(19) United States
(12) Patent Application Publication
(10) Pub. No.: US 2009/0018679 A1
(43) Pub. Date: Jan. 15, 2009

(54) TIME-SHIFTING DEVICE IN A HOME NETWORK

(75) Inventor: Jean-Benoit Pina, Paris (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,708

(22) PCT Filed: Dec. 15, 2004
(86) PCT No.: PCT/IB2004/004214

§ 371 Date: Jun. 22, 2006

(30) Foreign Application Priority Data
Dec. 31, 2003 (EP) 03300296.5

(51) Int. Cl. G06F 17/00

(52) U.S. Cl. 700/94

(57) ABSTRACT

The present invention relates to a home network connected to an external audio/video source to stream an audio/video content received from the external source on a digital television receiver, or set top box, of the home network. The home network comprises: —a gateway device comprising audio/video reception means to receive audio/video streams from a communication medium and audio/video transmission means to transmit said received audio/video streams to the home network, —a media center device having storage means for storing said audio/video steams received from the gateway device and audio/video re-transmission means to re-transmit said stored audio/video streams to the home network, —a control device comprising means for streaming audio/video streams received from the home network, said control device further comprising time-shifting means for triggering the recording on the media center of audio/video streams transmitted by the gateway device to the home network upon stopping the streaming of said transmitted audio/video streams on said control device, and for retrieving said recorded audio/video streams from the media center upon resuming the streaming of audio/video streams on the control device.

### FIELD OF THE INVENTION

The present invention relates to the field of audio/video transmissions in a home network. More particularly, it relates to a home network connected to an external audio/video source to stream an audio/video content received from the external source on a digital television receiver, or set top box, of the home network.

The invention further relates to a control device, a gateway device and a media center device of said home network.

### BACKGROUND OF THE INVENTION

The american patent application publication number US20030065803 describes a method of transmitting audio/video signals on an IP (Internet Protocol) network. It mentions the possibility to re-transmit audio/video streams received from the satellite to a local network. Several market analysis provide that a typical household will have in the future almost as many set top boxes (STBs) as television sets connected inside a Home Network (HN). It will consist of at least a high end STB with a hard disk (HD) acting as a gateway between the external world and the HN and one or more low end STB without storage capacity. Time-shifting features allowing to stop the streaming of an audio/video program and resume it without losing any data, as if the program was tape or DVD recorded, is now available in high end STBs with hard disks. The invention provides a solution to implement time-shifting like features on a low end STB without storage capacity.

### SUMMARY OF THE INVENTION

To achieve this, a home network according to the invention comprises:

a gateway device comprising audio/video reception means to receive audio/video streams from a communication medium and audio/video transmission means to transmit said received audio/video streams to the home network,

a media center device having storage means for storing said audio/video streams received from the gateway device and audio/video re-transmission means to re-transmit said stored audio/video streams to the home network,

a control device comprising means for streaming audio/video streams received from the home network, said control device further comprising time-shifting means for triggering the recording on the media center device of audio/video streams transmitted by the gateway device to the home network upon stopping the streaming of said transmitted audio/video streams on said control device, and for retrieving said recorded audio/video streams from the media center device upon resuming the streaming of audio/video streams on said control device.

The gateway device with the media center form a video server and means are provided in the home network, via the control device, to offer a time-shifting service over the home network to a low end STB acting as the control device.

In a preferred embodiment of the invention, the Universal Plug and Play (UPnP) interconnectivity architectures, as described in the documents UPnP Device Architecture 1.0, UPnP A/V Architecture, UPnP Media Renderer Device Control Protocol and UPnP Media Server sevice Control Protocol, are used to implement the invention. In this particular embodiment, using the UPnP standard allows hiding the notion of storage to the storageless STB. To this end, it is provided a home network as described above, wherein:

said audio/video transmission means of said gateway device include an UPnP MediaServer Service to send said received audio/video streams to a device of the home network including an UPnP MediaRenderer service to render said audio/video streams,

said storage means of said media center device include an UPnP MediaRenderer service that is used to store, in a predetermined file of the media center, said audio/video streams sent by said audio/video transmission means,

said audio/video re-transmission means of said media center include an UPnP MediaServer service to read the audio/video streams stored on said predetermined file and to transfer it to a device of the network having an UPnP MediaRenderer service,

said time shifting means for triggering the recording on the media center include means for transmitting the UPnP PAUSE command to the media center, accordingly activating said UPnP MediaRenderer service of said media center to store said audio/video streams on said predetermined file and

said time shifting means for retrieving said recorded audio/video streams from the media center include means for transmitting the UPnP PLAY command to the media center, accordingly activating said UPnP MediaServer service of said media center to read said audio/video streams from said predetermined file.

An UPnP device inside the media center is thus defined for time-shifting purpose throughout the home network. It comprises two UPnP services, based on the UPnP A/V architecture framework The first UPnP service allows redirecting the audio/video streams from the STB gateway to the media center for the streams to be recorded on its HD. The second UPnP service allows the streaming and time-shifting control of the streams between the media center and the control device, which can be a low-end STB. The media center is thus transformed into a video server and the control device acts as an UPnP Control Point including an UPnP MediaRenderer service to retrieve the stored audio/video streams from the media center.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawing, wherein:

FIG. 1 is a schematic diagram for illustrating an example of a home network system according to the invention.

### DETAILED DESCRIPTION OF THE INVENTION

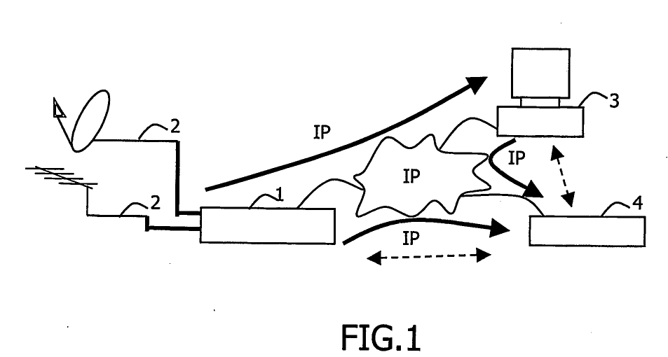

FIG. 1 represents a home network according to the invention, comprising:

a gateway device 1 comprising audio/video reception means to receive audio/video streams from a communication medium 2 and audio/video transmission means to transmit said received audio/video streams to the home network,

a media center device 3 having storage means for storing said audio/video streams received from the gateway device and audio/video re-transmission means to re-transmit said stored audio/video streams to the home network,

a control device 4 comprising means for streaming audio/video streams received from the home network, said control device further comprising time-shifting means for triggering the recording on the media center of audio/video streams transmitted by the gateway device to the home network upon stopping the streaming of said transmitted audio/video streams on said control device, and for retrieving said recorded audio/video streams from the media center upon resuming the streaming of audio/video streams on the control device.

The audio/video reception and (re-)transmission means are known the persons skilled in the art as well as the means for streaming the audio/video streams received from the home network. Therefore, they won't be described in further detail.

As an example, the Internet Protocol IP can be used to transmit the audio/video data from a device to another one on the home network. Assuming that a user wants to watch an audio/video program currently broadcast from the satellite or cable digital TV on its low end STB, the audio/video content would directly be streamed from the gateway STB to the Low End STB, acting as the control device 4, via the IP link in the home network. Now assuming that the user wants to “pause” the program for a while, to have a beer, and resume its watching without loosing anything from the audio/video program, the control device 4 will activate time-shifting means upon stopping the streaming of said audio/video streams to redirect the audio/video streams from the gateway device 1 to the media center 3 for them to be recorded and then to retrieve the recorded audio/video content from the media center 3 for it to be streamed on the low end STB upon receiving a “resuming” command from the user to resume the streaming of the audio/video program.

For this to work, the time-shifting feature must be known to the home network. To offer the time-shifting feature on a home network, the following method can be used. The Low End STB 3 sends a multicast request on the HN for all devices having local storage. A device with available storage capacity, for example a STB with a hard disk acting as a media server 3, replies with its shared storage capacity. The shared capacity is a spare memory space like a predetermined file on the local hard disk of the media center 3, which is reserved for the network's needs. It can be implemented, for example, with a circular buffer. The position wherefrom the audio/video streams are read must be backward shifted with respect to the position whereto said audio/video streams are stored on the circular buffer by a time shift period corresponding to the time period of the “pause”. Preferably, the time shift period is equal or shorter than a predefined reference time period. The size of the shared storage area of the storage device can be predetermined by the user, which consequently limits the time shift period. It is to be noted that the storage capacity needed for the time-shifting feature is temporary, unlike persistently recorded data whose archiving has to be taken into account, as when burning a CD/DVD or using persistent storage on the hard disk, which decreases the available space of the hard disk.

Then, using for example the RTSP (Real Time Streaming Protocol, as described in RFC2326) protocol, the low end STB 4 can send a request to the device 3 having storage capacity for recording the program to be resumed after a pause. The audio/video stream is then re-routed by the STB gateway 1 to the device 3 with storage capacity. The RTSP protocol enables the Low End STB 4 to send PLAY, PAUSE commands on the network to the device 3 having storage capacity so that it can provide a time-shifting like feature without local storage. Reception of a PAUSE command triggers the storing of the received stream on the device 3 having storage capacity. Then, upon reception of a PLAY command from the low end STB, the device 3 streams the audio/video content over RTP (Real-Time Transport Protocol as defined in RFC1889). Exchange of control commands over the home network is represented in FIG. 1 by two-pointed arrows in discontinued lines.

It is to be noted that a more common usage of this solution may take place in a two-STB Home Network, the STB gateway being a High End STB with local storage, serving as a media server to a low end STB.

According to a preferred embodiment of the invention, the UPnP standard protocol is used to implement the invention. To provide the time-shifting feature, the low end STB 4 simply has to send the PAUSE/PLAY (and eventually Trick-Mode commands to perform (fast) forward, (fast) rewind and slow motion operations) to the media center 3, which accordingly stores and reads the audio/video streams on and from its hard disk and transfers the read stream to the Low End STB 4. In this embodiment the following steps are performed. The low end STB 4 uses the discovery feature of UPnP to look for an UPnP time-shifting device. A device with storage capacity, the Media Center 3, replies by offering the two UPnP Services that are usefull for the time-shifting feature: an UPnP MediaServer Service and an UPnP MediaRenderer Service. The Low End STB 4, behaving as an UPnP Control Point, controls the STB gateway 1 and the media center 3 to redirect the audio/video stream from the STB gateway 1 to the media center 3, so that the stream can be recorded on the media center 3. The recording of the audio/video streams on the media center is triggered by transmitting the UPnP PAUSE command from the low end STB 4 to the media center, accordingly activating the UPnP MediaRenderer service of the media center to store said audio/video streams on a predetermined file of the media center 3. Resuming the streaming of the audio/video content on the low end STB is triggered by the low end STB 4, still behaving as an UPnP Control Point, sending a PLAY command to the media center 3 so that the audio/video stream can be read from the predetermined file of the media center 3 local storage to be streamed to the low end STB 4.

In the case the predetermined file is a circular buffer, the position wherefrom said audio/video stream is read by the MediaServer service of the media center is backward shifted with respect to the position whereto said audio/video stream is stored by the mediaRenderer service of the media center by a time shift period corresponding to the period of time between the receptions of said subsequent PAUSE and PLAY commands by said media center. To avoid using too much memory space on the media center, the time shift period is preferably equal or shorter than a predefined reference time period, corresponding for example to 15 to 30 minutes of the audio/video stream.

It is to be noted that any device providing high-speed access to the HN and storage can be used (with additional software) to implement the media center, like typically a desktop or laptop computer. The resource reservation mechanism is only based on the available storage space. It could be enhanced to take into account more parameters, as the current central processing unit load of the device, a-priority level for access to storage or the bandwidth load of the device or of the share of the network onto which the audio/video streams will be delivered.

Another application of the invention is to enable a low end STB being for example a video on Demand STB to use time-shifting features of the home network to stream live audio video contents received from an external source like a satellite or terrestrial broadcast program. In this case, the video on demand STB receives the broadcast programs via the media center, which continuously stores the broadcast audio/video stream in his circular buffer before reading it locally and sending it to the STB.

The drawings and their description hereinbefore illustrate rather than limit the invention. It will be evident that there are numerous alternatives that fall within the scope of the appended claims. In this respect, the following closing remarks are made.

There are numerous ways of implementing functions by means of items of hardware or software, or both. In this respect, the drawing is very diagrammatic, representing only one possible embodiment of the invention. Thus, although a drawing shows different functions as different blocks, this by no means excludes that a single item of hardware or software carries out several functions. Nor does it exclude that a function is carried out by an assembly of items of hardware or software, or both.

Practically, the invention is implemented using software means. To this end, devices according to the invention comprise one or several processors and one or several storage means to store computer programs comprising instructions to implement the functions that have been described, when theses functions are executed by the processors.

1. A home network comprising:
a gateway device comprising audio/video reception means to receive audio/video streams from a communication medium and audio/video transmission means to transmit said received audio/video streams to the home network,
a media center device having storage means for storing said audio/video streams received from the gateway device and audio/video re-transmission means to re-transmit said stored audio/video streams to the home network,
a control device comprising means for streaming audio/video streams received from the home network, said control device further comprising time-shifting means for triggering the recording on the media center device of audio/video streams transmitted by the gateway device to the home network upon stopping the streaming of said transmitted audio/video streams on said control device, and for retrieving said recorded audio/video streams from the media center device upon resuming the streaming of audio/video streams on said control device.

2. A home network as claimed in claim 1, wherein:
said audio/video transmission means of said gateway device include an UPnP MediaServer Service to send said received audio/video streams to a device of the home network including an UPnP MediaRenderer service to render said audio/video streams,
said storage means of said media center device include an UPnP MediaRenderer service that is used to store, in a predetermined file of the media center, said audio/video streams sent by said audio/video transmission means,
said audio/video re-transmission means of said media center include an UPnP MediaServer service to read the audio/video streams stored on said predetermined file and to transfer it to a device of the network having an UPnP MediaRenderer service,
said time shifting means for triggering the recording on the media center include means for transmitting the UPnP PAUSE command to the media center, accordingly activating said UPnP MediaRenderer service of said media center to store said audio/video streams on said predetermined file and
said time shifting means for retrieving said recorded audio/video streams from the media center include means for transmitting the UPnP PLAY command to the media center, accordingly activating said UPnP MediaServer service of said media center to read said audio/video streams from said predetermined file.

3. A home network as claimed in claim 2, wherein said predetermined file is a circular buffer, the position wherefrom said audio/video streams are read by said MediaServer service of said media center being backward shifted with respect to the position whereto said audio/video streams are stored by said mediaRenderer service of said media center by a time shift period corresponding to the period of time between the receptions of said subsequent PAUSE and PLAY commands by said media center.

4. A home network as claimed in claim 3, wherein said time shift period is equal or shorter than a predefined reference time period.

5. In a home network comprising:
a gateway device comprising audio/video reception means to receive audio/video streams from a communication medium and audio/video transmission means to transmit said received audio/video streams to the home network,
a media center device having storage means for storing said audio/video streams received from the gateway device and audio/video re-transmission means to re-transmit said stored audio/video streams to the home network,
a control device comprising means for streaming audio/video streams received from the home network, said control device further comprising time-shifting means for triggering the recording on the media center of audio/video streams transmitted by the gateway device to the home network upon stopping the streaming of said transmitted audio/video streams on said control device, and for retrieving said recorded audio/video streams from the media center upon resuming the streaming of audio/video streams on the control device.

6. In a home network, a gateway device comprising audio/video reception means to receive audio/video streams from a communication medium and audio/video transmission means to transmit said received audio/video streams to the home network, said home network further comprising:
a media center device having storage means for storing said audio/video streams received from the gateway device and audio/video re-transmission means to re-transmit said stored audio/video streams to the home network and
a control device comprising means for streaming audio/video streams received from the home network, said control device further comprising time-shifting means for triggering the recording on the media center of audio/video streams transmitted by the gateway device to the home network upon stopping the streaming of said transmitted audio/video streams on said control device, and for retrieving said recorded audio/video streams from the media center upon resuming the streaming of audio/video streams on the control device.

7. In a home network comprising:
a gateway device comprising audio/video reception means to receive audio/video streams from a communication medium and audio/video transmission means to transmit said received audio/video streams to the home network, and
a control device comprising means for streaming audio/video streams received from the home network,
a media center device comprising means for recording audio/video streams transmitted by the gateway device upon stopping the streaming on said control device of audio/video streams transmitted by said gateway device and means for sending said recorded audio/video streams to the control device upon a retrieve command is received by said media center from said control device for resuming the streaming of said received audio/video streams on the control device after said stop.
